(19) United States
(12) Patent Application Publication
(10) Pub. No.: US 2025/0309989 A1
(43) Pub. Date: Oct. 2, 2025

(54) TECHNOLOGIES FOR OPTICAL EQUALIZERS

(71) Applicant: Intel Corporation, Santa Clara, CA (US)

(72) Inventors: Khaled Ahmed, San Jose, CA (US); Benjamin T. Duong, Phoenix, AZ (US); Nicholas D. Psaila, Lanark (GB); Mostafa Naguib Abdulla, Rancho Cordova, CA (US); Mozhgan Mansuri, Portland, OR (US); James E. Jaussi, El Dorado Hills, CA (US)

(73) Assignee: Intel Corporation, Santa Clara, CA (US)

(21) Appl. No.: 18/621,199

(22) Filed: Mar. 29, 2024

(51) Int. Cl. H04B 10/294; H04B 10/2507; H04J 14/02

(52) U.S. Cl. CPC H04B 10/2941; H04B 10/25073; H04J 14/0221

(57) ABSTRACT

Technologies for optical equalizers with metasurfaces are disclosed. In an illustrative embodiment, an optical equalizer can be formed from two metasurfaces. The metasurfaces reflect light in different directions depending on the spatial mode of the light. The metasurfaces can be used to change the optical path length of different modes of light from an optical input to an optical output, such as from an optical fiber to a photodiode. The optical equalizer can delay some modes of light relative to other modes, partially or fully compensating for mode dispersion in a multi-mode optical fiber.

### BACKGROUND

As computing power increases, the bandwidth requirement likewise increases for communication over short distances, such as for communication between dies on the same circuit board or between circuit boards near each other. Copper traces and other electrical conductors are commonly used to carry high-bandwidth signals, but as frequencies increase, copper traces have more loss. In some cases, the loss for high-frequency signals can be significant even for dies adjacent to each other on the same circuit board. For longer distances, optical communication, such as using photonic integrated circuit (PIC) dies, can offer high-speed, lower power, compact communication. However, PIC dies may not be suitable for short distances due to high costs.

### BRIEF DESCRIPTION OF THE DRAWINGS

FIG. 1 is an isometric view of a system including an integrated circuit package with an optical equalizer.

FIG. 2 is a top-down view of the system of FIG. 1.

FIG. 3 is a cross-sectional view of one embodiment of the system of FIG. 1.

FIG. 4 is a cross-sectional view of one embodiment of the optical equalizer of FIG. 1.

FIG. 5 is a cross-sectional view of one embodiment of the optical equalizer of FIG. 1.

FIG. 6 is a cross-sectional view of one embodiment of a system including an integrated circuit package with an optical equalizer.

FIG. 7 is a cross-sectional view of one embodiment of a system including an integrated circuit package with an optical equalizer.

FIG. 8 is a cross-sectional view of one embodiment of a system including an integrated circuit package with an optical equalizer.

FIG. 9 is a cross-sectional view of one embodiment of a system including an integrated circuit package with an optical equalizer.

FIG. 10 is a cross-sectional view of one embodiment of a system including an integrated circuit package with an optical equalizer.

FIG. 11 is a cross-sectional view of one embodiment of a metasurface.

FIG. 12 is a top view of a wafer and dies that may be included in a microelectronic assembly, in accordance with any of the embodiments disclosed herein.

FIG. 13 is a cross-sectional side view of an integrated circuit device that may be included in a microelectronic assembly, in accordance with any of the embodiments disclosed herein.

FIGS. 14A-14D are perspective views of example planar, gate-all-around, and stacked gate-all-around transistors.

FIG. 15 is a cross-sectional side view of an integrated circuit device assembly that may include a microelectronic assembly, in accordance with any of the embodiments disclosed herein.

FIG. 16 is a block diagram of an example electrical device that may include a microelectronic assembly, in accordance with any of the embodiments disclosed herein.

### DETAILED DESCRIPTION

In various embodiments disclosed herein, a system for communication over multi-mode optical fibers includes an optical equalizer. In use, a pulse of light is injected into a multi-mode optical fiber, such as from a micro-light-emitting diode (micro-LED). The light is coupled into several optical modes in the multi-mode optical fiber. As the light traverses the optical fiber, different optical modes travel at different speeds, causing the pulse of light to be spread out in time. In order to partially or fully compensate for this modal dispersion, an optical equalizer can be used. The illustrative optical equalizer includes a dielectric structure forming a metasurface that reflects different spatial modes of light differently. The reflected light can be reflected off of one or more mirrors and is incident on another dielectric structure, forming another metasurface. The second metasurface also reflects the different spatial modes differently, reflecting them towards a photodetector. Between the two metasurfaces, light in different spatial modes travel different distances, at least partially compensating for the dispersion in the multi-mode optical fiber.

As used herein, the phrase “communicatively coupled” refers to the ability of a component to send a signal to or receive a signal from another component. The signal can be any type of signal, such as an input signal, an output signal, or a power signal. A component can send or receive a signal to another component to which it is communicatively coupled via a wired or wireless communication medium (e.g., conductive traces, conductive contacts, air). Examples of components that are communicatively coupled include integrated circuit dies located in the same package that communicate via an embedded bridge in a package substrate and an integrated circuit component attached to a printed circuit board that send signals to or receives signals from other integrated circuit components or electronic devices attached to the printed circuit board.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact, and “coupled” may indicate elements co-operate or interact, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, the central axis of a magnetic plug that is substantially coaxially aligned with a through hole may be misaligned from a central axis of the through hole by several degrees. In another example, a substrate assembly feature, such as a through width, that is described as having substantially a listed dimension can vary within a few percent of the listed dimension.

It will be understood that in the examples shown and described further below, the figures may not be drawn to scale and may not include all possible layers and/or circuit components. In addition, it will be understood that although certain figures illustrate transistor designs with source/drain regions, electrodes, etc. having orthogonal (e.g., perpendicular) boundaries, embodiments herein may implement such boundaries in a substantially orthogonal manner (e.g., within +/−5 or 10 degrees of orthogonality) due to fabrication methods used to create such devices or for other reasons.

Reference is now made to the drawings, which are not necessarily drawn to scale, wherein similar or same numbers may be used to designate the same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

As used herein, the phrase “located on” in the context of a first layer or component located on a second layer or component refers to the first layer or component being directly physically attached to the second part or component (no layers or components between the first and second layers or components) or physically attached to the second layer or component with one or more intervening layers or components.

As used herein, the term “adjacent” refers to layers or components that are in physical contact with each other. That is, there is no layer or component between the stated adjacent layers or components. For example, a layer X that is adjacent to a layer Y refers to a layer that is in physical contact with layer Y.

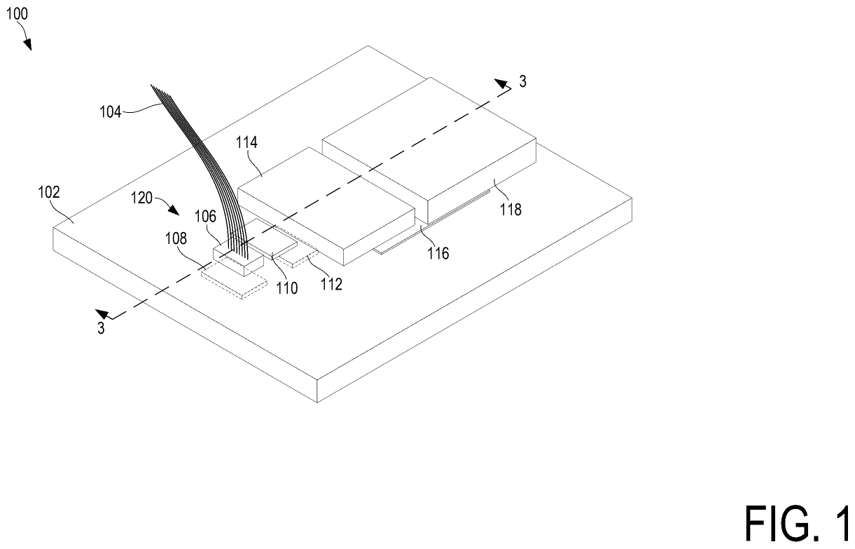

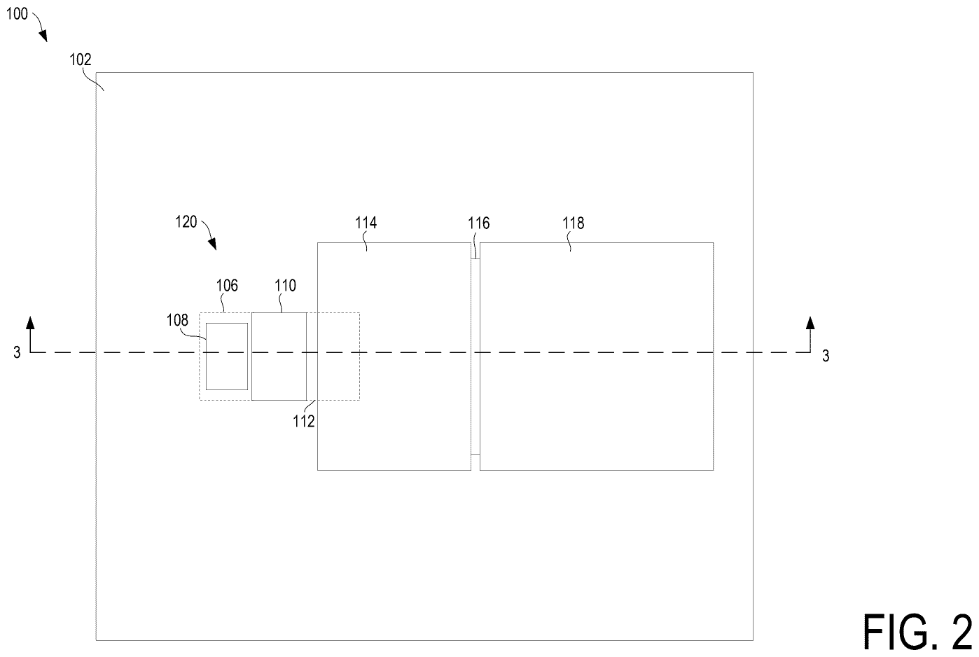

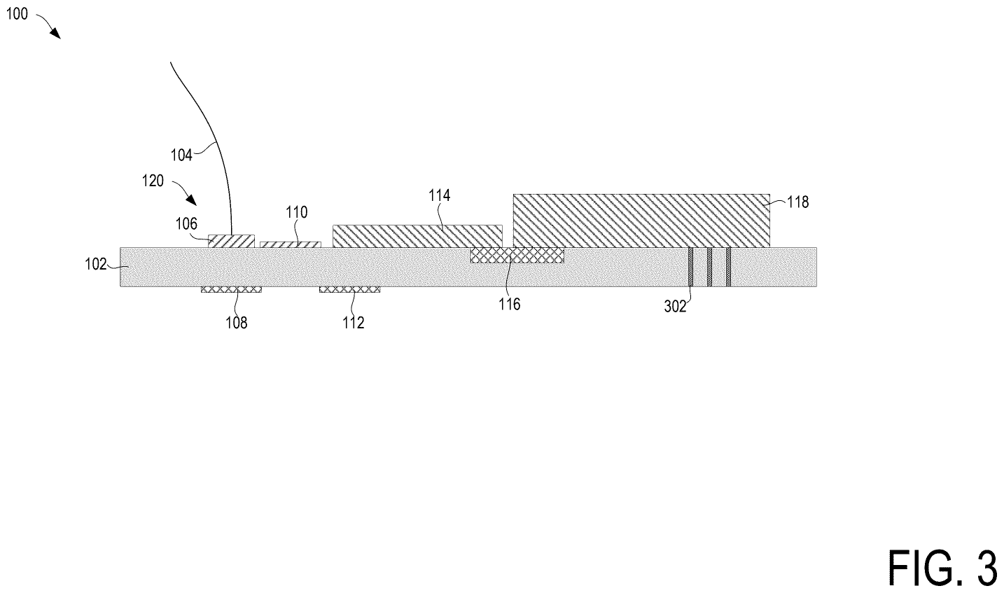

Referring now to FIGS. 1-3, in one embodiment, an integrated circuit package 100 includes a substrate 102, a first metasurface 108, a mirror 110, a second metasurface 112, a photodetector die 114, a bridge die 116, and an electronic integrated circuit (EIC) die. An optical plug 106 connects one or more multi-mode optical fibers 104 to the integrated circuit package 100. FIG. 1 shows a perspective view of the integrated circuit package 100, FIG. 2 shows a top-down view of the integrated circuit package 100, and FIG. 3 shows a cross-sectional view of one embodiment of the integrated circuit package 100.

In use, in an illustrative embodiment, another component, such as another integrated circuit package, transmits pulses of light in the multi-mode optical fibers 104. The light can be transmitted to represent data, such as using amplitude shift keying. The multi-mode optical fibers 104 support a range of optical modes. For example, in some embodiments, the modes in the multi-mode optical fibers can be enumerated as LPₗₘ modes, where l and m indicate the number of field zeroes around the mode's azimuthal (angular) direction and the number of radial nodes, respectively. The lowest-order mode is LP₀₁. As l and m increase, the speed of the mode along the fiber generally decreases. As a result, different modes that are transmitted as part of the same optical pulse are spread out in time when received at the integrated circuit package 100 due to modal dispersion. For example, in one embodiment, the mode-dependent delay may be on the order of 0.1-0.2 nanoseconds. In other embodiments, the mode-dependent delay may be, e.g., 0.01-2 nanoseconds. The amount of mode-dependent delay may be calibrated to correspond to the amount of delay induced by the optical fiber 104. In particular, the amount of delay may be calibrated based on the length of the fiber 104. For example, an optical equalizer 120 used to compensate for dispersion in an optical fiber that is five meters long may implement five times as much mode-dependent-delay as an optical equalizer 120 that is used to compensate for dispersion in the same type of optical fiber that is one meter long.

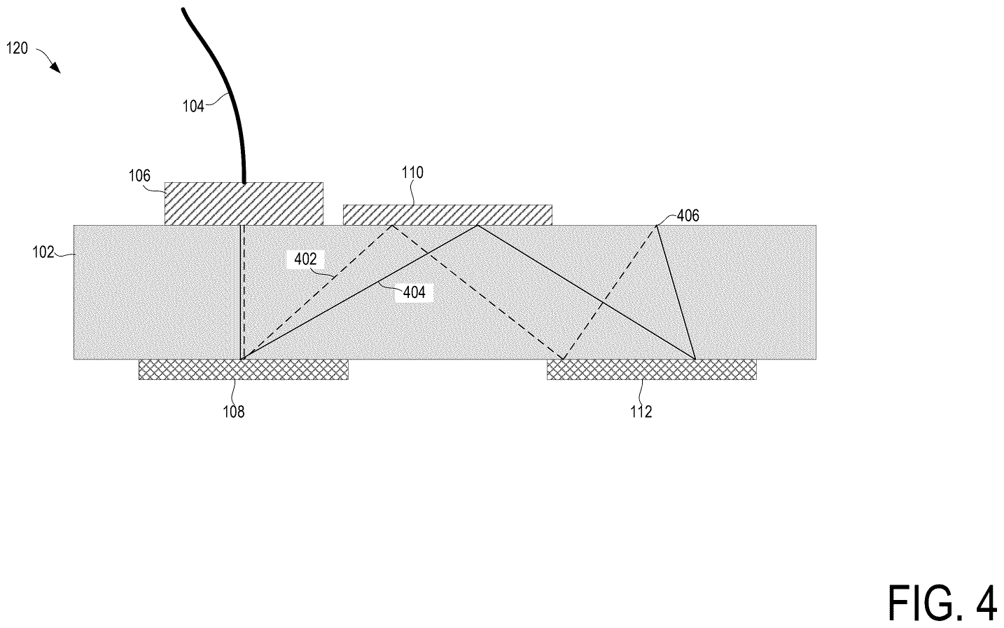

In order to compensate for the modal dispersion, the integrated circuit package 100 includes an optical equalizer 120 made up of the first metasurface 108, a mirror 110, and the second metasurface 112. As shown in FIG. 4, light in one spatial mode 402 reflects off of the metasurface 108 differently than light in another spatial mode 404. The light in both spatial modes 402, 404 reflect off of the mirror 110, and the second metasurface 112 also reflects the light in the spatial modes 402, 404 in a spatial-mode-dependent manner, reflecting both spatial modes 402, 404 to the same spot 406, where a photodetector can detect them, such as photodetector die 114 shown in FIG. 3. The optical path length from the first metasurface 108 to the spot 406 is spatial-mode-dependent, with higher-order LP modes taking a shorter path, partially or fully compensating for the slower speed in the multi-mode optical fiber 104.

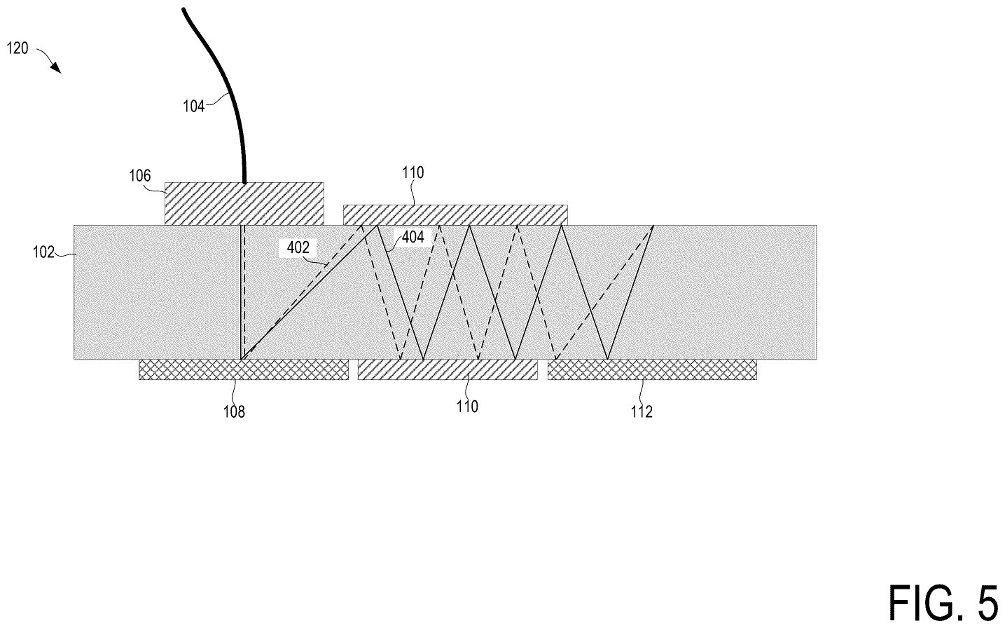

In some embodiments, as shown in FIG. 5, the optical equalizer 120 may include multiple reflections between the metasurfaces 108, 112. Multiple reflections may increase the mode-dependent delay. In some embodiments, the optical equalizer 120 may compensate for chromatic dispersion, in addition to or as an alternative to compensating for modal dispersion.

In an illustrative embodiment, the metasurfaces 108, 112 are formed from a periodic lattice of subwavelength dielectric structures. The subwavelength size allows for compact and flat structures. In some embodiments, the metasurfaces 108, 112 may use metallic structures and/or may use plasmonic metasurfaces 108, 112. The metasurfaces 108, 112 can operate in a similar manner as a spatial light modulator, precisely varying the local phase and amplitude of the reflection. As the different modes have different amplitude profiles, the different modes will interact with different parts of the metasurfaces 108, 112, allowing for the different modes to be reflected differently.

The illustrative substrate 102 is glass, such as silicon oxide glass. In other embodiments, the substrate 102 may be made of any suitable material that may be crystalline, non-crystalline, amorphous, etc., such as fused silicon, borosilicate, sapphire, yttrium aluminum garnet, etc. The glass substrate 102 may be, e.g., aluminosilicate glass, borosilicate glass, alumino-borosilicate glass, silica, fused silica. The glass substrate 102 may include one or more additives, such as Al2O3, B2O3, MgO, CaO, SrO, BaO, SnO2, Na2O, K2O, SrO, P2O3, ZrO2, Li2O, Ti, and Zn. The glass substrate 102 may comprise silicon and oxygen, as well as any one or more of aluminum, boron, magnesium, calcium, barium, tin, sodium, potassium, strontium, phosphorus, zirconium, lithium, titanium, and zinc. The glass substrate 102 may include at least 20-40 percent silicon by weight, at least 20-40 percent oxygen by weight, and at least 5 percent aluminum by weight. For example, some embodiments of the glass substrate 102 may include, e.g., at least 20-23 percent silicon and at least 20-26 percent oxygen by weight.

In other embodiments, the substrate 102 may be any suitable material, such as a ceramic substrate or an organic substrate. In some embodiments, the substrate 102 may be embodied as a printed circuit board made from ceramic and/or organic-based materials with fiberglass and resin, such as FR-4. The substrate 102 may have any suitable length or width, such as 10-500 millimeters. The substrate 102 may have any suitable thickness, such as 0.2-5 millimeters. The substrate 102 may support additional components besides those shown in FIG. 3, such as one or more build-up layers, additional EIC dies, additional bridge dies, photonic integrated circuit (PIC) dies, waveguides integrated into the substrate 102, additional through-substrate vias, traces, etc. Other components in the integrated circuit package 100 that may be directly or indirectly mounted on or coupled to the substrate 102 include additional photonic or electronic integrated circuit components, a processor unit, a memory device, an accelerator device, etc.

The optical fibers 104 may be any suitable optical fibers, such as glass optical fibers. In some embodiments, the optical fibers 104 may be plastic, such as polymethyl methacrylate (PMMA). The optical fibers 104 may have any suitable index profile, such as a step index, a graded index, etc. The optical fibers 104 may have a core of any suitable diameter, such as 20-500 micrometers. The system may include any suitable number of optical fibers 104 connected to the integrated circuit package 100, such as 1-1,024.

In an illustrative embodiment, the optical fibers 104 interface with the integrated circuit package 100 through optical plug 106. The optical plug 106 may mate with an optical receptacle mounted on the substrate 102 or other part of the integrated circuit component 100. The optical plug 106 may include or interface with an optical interposer that includes one or more waveguides that are optically coupled to the optical fibers 104.

The dielectric structures that make up the metasurfaces 108, 112 may be made of any suitable material or combination of materials, such as silicon dioxide, silicon nitride, sapphire, quartz, polymers, etc. The metasurfaces 108, 112 may be formed using, e.g., lithography, etching, deposition, lift-off techniques, and/or the like. The metasurfaces 108, 112 may have any suitable dimensions, such as a width across the page from the perspective of FIG. 3 of, e.g., 2-50 millimeters and a thickness of, e.g., 1-5,000 micrometers. The metasurfaces 108, 112 may have any suitable length extending into and out of the page from the perspective of FIG. 3, such as 2-500 millimeters. It should be appreciated that, in some embodiments, different parts of the metasurfaces 108, 112 may interact with light from different optical fibers 104. For example, an array of, e.g., 16 optical fibers may carry light that is directed onto different areas of the same metasurfaces 108, 112.

In an illustrative embodiment, the photodetector die 114 is embodied as one or more microphotodiodes 114. The illustrative microphotodiodes may be similar to micro-light-emitting diodes (micro-LEDs) with an opposite bias in order to detect light rather than create it. Additionally or alternatively, in some embodiments, the die 114 may be embodied as one or more micro-LED dies 114 that transmit light to another device. The light from the micro-LED dies 114 may be coupled to multiple modes in the optical fibers 104, leading the modal dispersion, as described above. In some embodiments, the optical equalizer 120 may be used to partially or fully pre-compensate for the spatial dispersion in the optical fiber 104. In some embodiments, an optical equalizer 120 may be at both the transmit side and the receive side, where the total dispersion compensation by the equalizers 120 is approximately equal and opposite to the dispersion caused by the optical fiber 104.

In embodiments with micro-LEDs, the micro-LEDs 114 may be any suitable micro-LED, such as gallium nitride micro-LEDs, quantum dot LEDs, single nanowire LED, etc. As used herein, a micro-LED refers to a light-emitting diode with a length and width of a light-emitting surface of less than 100 micrometers. In some embodiments, the length and/or width of a light-emitting surface of the micro-LEDs 114 may be smaller, such as less than 10-50 micrometers. In the illustrative embodiment, the micro-LEDs 114 are created on a separate substrate and transferred to a base die, the substrate 102, or other substrate or die. In an illustrative embodiment, the integrated circuit package 100 may include one micro-LED die 114 for each optical fiber 104 connected to the integrated circuit package 100.

In embodiments with photodiodes 114, the photodiodes 114 may be made from any suitable materials, such as silicon, silicon-germanium (SiGe), a III-V material including those listed above for the micro-LEDs 114, etc. In some embodiments, the photodiodes 114 may be microphotodiodes 114. As used herein, a microphotodiode 114 refers to a photodiode with a length and width of a light-sensitive surface of less than 100 micrometers. In some embodiments, the length and/or width of a light-sensitive surface of the microphotodiodes 114 may be smaller, such as less than 10-50 micrometers. Similar to the micro-LEDs 114, the photodiodes 114 may be created on a separate substrate and transferred to a base die. In some embodiments, the photodiodes 114 may be able to be used as micro-LEDs 114 and/or the micro-LEDs 114 may be able to be used as photodiodes 114. In the illustrative embodiment, each micro-LED 114 and microphotodiode 114 interfaces with the die or substrate 102 on which they are mounted through a copper pad on the die or substrate 102 and a transparent electrode on top of the micro-LED 114 or microphotodiode 114. The transparent electrode may be any suitable transparent conductive material, such as indium tin oxide (ITO). The micro-LEDs 114 and/or photodiodes 114 may be secured to the base die or substrate 102 in any suitable manner, such as by using solder, hybrid bonding, etc.

In the illustrative embodiment, the photodiodes 114 are spaced apart from other photodiodes 114 and/or from micro-LEDs 114 in order to prevent cross-talk. The photodiodes 114 and/or micro-LEDs 114 may be spaced apart by, e.g., 10-500 micrometers, as measured from the center of one photodiode 114 and/or micro-LED 114 to the next. In some embodiments, the photodiodes 114 may be responsive to a similar wavelength range as a corresponding micro-LED 114, and different micro-LEDs 114 may have different wavelength ranges. The photodiodes 114 and/or micro-LEDs 114 may operate at any suitable wavelength, such as 380-1,650 nanometers, depending on the particular material and structure of the micro-LED 114 and/or photodiode 114. In the illustrative embodiment, the micro-LED 114 and/or photodiode 114 may operate at a wavelength between, e.g., 400-450 nanometers. The micro-LED 114 and/or photodiode 114 may have any suitable bandwidth, such as 1-15 nanometers.

Each micro-LED 114 and/or photodiode 114 may be connected to a drive and/or receive circuit, respectively, that interfaces with other electronic components of the base die, substrate 102, EIC die 118, etc. The integrated circuit package 100 may include any suitable number of micro-LEDs 114 and/or photodiodes 114, such as 1-10,000. Each micro-LED 114 may transmit, and each photodiode 114 may receive data at a rate of, e.g., 1-128 gigabits per second. In the illustrative embodiment, the EIC die 118 may send and receive data by modulating/demodulating the micro-LED 114/photodiode 114 at different amplitudes, such as on and off. Any suitable encoding may be used, such as return-to-zero encoding, non-return-to-zero encoding, amplitude shift keying, multilevel amplitude shift keying, pulse amplitude modulation, phase shift keying, quadrature amplitude modulation, etc. In the illustrative embodiment, data can be transferred by a micro-LED 114 to a photodiode 114 with an energy efficiency of, e.g., 0.1-0.5 picojoules per bit. In other embodiments, data can be transferred by a micro-LED 114 to a photodiode 114 with an energy efficiency of, e.g., less than 0.5-5 picojoules per bit. In an illustrative embodiment, the micro-LEDs 114 and photodiodes 114 can operate at a relatively wide temperature range, such as −40° C. to 125° C. The high maximum temperature can make the micro-LEDs 114 and photodiodes 114 suitable for operating adjacent a high-power semiconductor die 118, such as a processor die or GPU die.

The integrated circuit package 100 may include the micro-LEDs 114 and/or photodiodes 114 in any suitable configuration, such as a linear array, a two-dimensional array, etc. The micro-LEDs 114 and/or photodiodes 114 may have any suitable size, such as an array with a length and/or width of 1-1,000 micro-LEDs 114 or photodiodes 114.

It should be appreciated that micro-LEDs are merely one possible light source that could be used with the techniques disclosed herein. In general, any other suitable multi-mode or single-mode light sources may be used. For example, in some embodiments, the die 114 may additionally or alternatively be embodied as any suitable photonic die 114, such as a vertical cavity surface emitting laser (VCSEL), a silicon photonic die including one or more light sources or photodetectors, etc. The die 114 may be a photonic integrated circuit (PIC) die made of any suitable material, such as silicon. The PIC die 114 may have waveguides defined within it, such as silicon waveguides embedded in silicon oxide cladding. The PIC die 114 may include any suitable number of waveguides, such as 1-1,024. In an illustrative embodiment, the waveguides in the PIC die 114 are edge-coupled waveguides. In other embodiments, the waveguides may be vertically coupled out of the PIC die 114. In some embodiments, the PIC die 114 may be embodied as or include, e.g., indium phosphide, gallium arsenide, lithium niobate, silicon nitride, chalcogenide, and/or the like.

In some embodiments, the PIC die 114 may be configured to generate, detect, and/or manipulate light. The PIC die 114 may include active or passive optical elements such as splitters, couplers, filters, optical amplifiers, lasers, photodetectors, modulators, routers, etc. The PIC die 114 may operate at any suitable wavelength, such as 400-2,000 nanometers.

It should be appreciated that, in an illustrative embodiment, no serialization/deserialization (serdes) may be required in order to send and receive signals using the optical fibers 104, micro-LEDs 114, and/or photodiodes 114. Rather, each signal of a bus may be sent directly on a dedicated channel. Such an approach can simplify implementations, reduce latency, and increase system performance.

The mirror 110 may be any suitable object or material for reflecting light, such as a metallic or dielectric mirror. For example, the mirror may be embodied as silver, aluminum, silicon, a dielectric stack, etc. In some embodiments, the mirror 110 may be embodied as a metasurface 110. The mirror 110 may be a separate component from the substrate 102, such as silicon oxide covered with a mirror layer. In some embodiments, a mirror layer, such as silver, aluminum, silicon, a dielectric stack, etc., may be deposited directly on the substrate 102 or other component of the integrated circuit package 100.

The EIC die 118 may include any suitable electronic integrated circuit component, such as resistors, capacitors, inductors, transistors, etc. The EIC die 118 may include any suitable analog and/or digital circuitry, such as a processor, a memory, an application-specific integrated circuit (ASIC), a field-programmable gate array (FPGA), etc. In an illustrative embodiment, the EIC die 118 may be embodied as an xPU, such as a central processing unit or a graphics processing unit. The EIC die 118 may be embodied as or otherwise include circuitry to drive components on the die 114, such as lasers, modulators, etc., and/or the EIC die 118 may be embodied as or otherwise include circuitry to receive signals from components on the PIC die 114, such as photodetectors. The EIC die 118 may use the die 114 to communicate using optical signals with other dies in the same package 100, other integrated circuit packages, other compute devices, etc. In some embodiments, the integrated circuit package 100 may be embodied as a router, a switch, a network interface controller, and/or the like. In such embodiments, the EIC die 118 may include network interface controller circuitry to process, parse, route, etc., network packets sent and received by the integrated circuit package 100.

In an illustrative embodiment, the EIC die 118 is mounted on the substrate 102. The EIC die 118 may be connected to the substrate 102 through pads and/or solder bumps. The pads and/or solder bumps may be used to transmit and receive signals between the EIC die 118 and the substrate 102, provide power to the EIC die 118, etc. The substrate 102 may provide various electrical connections. For example, the substrate 102 may include a redistribution layer on the bottom of the substrate 102 and/or may include a redistribution layer on the top of the substrate 102, which may be embodied as one or more build-up layers. In some embodiments, one or more vias 302 may extend through the substrate 102. The vias 302 may be used to provide power, I/O, letch, etc., to the EIC die 118 and/or other components, such as the bridge die 116, the dies 114, etc.

The bridge die 116 provides interconnect circuitry for connections between the EIC die 118 and the dies 114. The bridge die 116 may be embodied as, e.g., an embedded multi-die interconnect bridge (EMIB) or an omni-directional interconnect (ODI). The bridge die 116 may carry power signals and/or data signals to, from, or between any suitable combination of the EIC die 118, the dies 114, and/or the substrate 102. The bridge die 116 may include any suitable number of power and/or data signal pads connected to the EIC die 118, the dies 114, or other component, such as 1-1,024 pads.

It should be appreciated that the embodiment described above in regard to FIGS. 1-3 is merely one possible embodiment, and other embodiments are envisioned as well. Several embodiments are described below, but the approach described herein can extend to any suitable arrangement of an optical equalizer, such as an optical equalizer that includes the substrate 102, a discrete optical equalizer mounted on the substrate 102 or other component, an optical equalizer that interfaces with one or more waveguides, and optical interface that interfaces with free-space modes, and/or any suitable combination thereof.

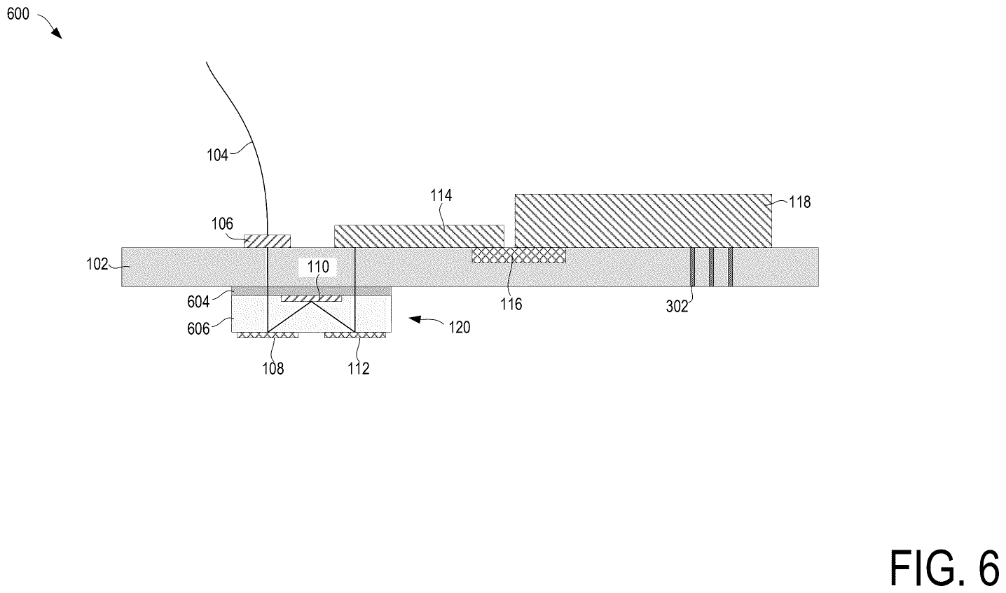

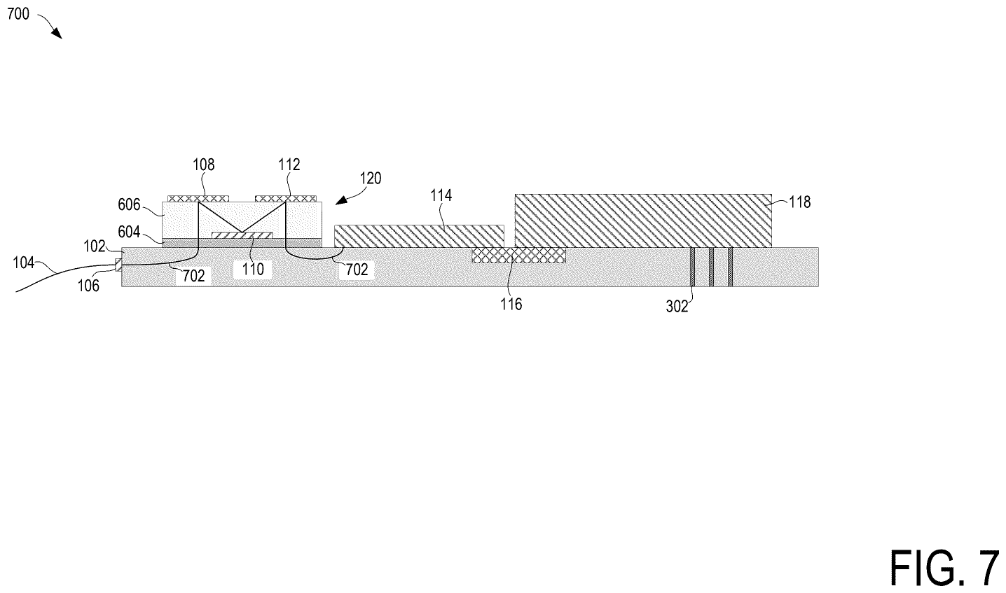

Referring now to FIG. 6, in one embodiment, an integrated circuit package 600 includes a discrete optical equalizer 120 mounted on a substrate 102. The various components of the integrated circuit package 600 (and other integrated circuit packages described below in regard to FIGS. 7-10) may include similar or the same components as the integrated circuit package 100, a description of which will not be repeated in the interest of clarity. The optical equalizer 120 includes metasurfaces 108, 112 and one or more mirrors 110. The optical equalizer 120 includes a transparent substrate 606, which may be any suitable material, including any material described above in regard to the substrate 102. The optical equalizer 120 may be mounted on the substrate 102 using an index matching epoxy 604. The light from the optical fibers 104 may pass through the substrate 102 to get to the optical equalizer 120, as shown in the figure.

Referring now to FIG. 7, in one embodiment, an integrated circuit package 700 includes a discrete optical equalizer 120 mounted on the substrate 102 in a similar manner as for the integrated circuit package 600. In the integrated circuit package 700, the optical fibers 104 interface on a side of the substrate 102, such as by plugging the optical plug 106 into a receptacle mounted on the side of the substrate 102. Each optical fiber 104 is coupled to a waveguide 702 defined in the substrate 102. The waveguide 702 routes the light from the optical fiber 104 to the optical equalizer 120, and another waveguide 702 routes the light from the optical equalizer 120 to the photodiode die 114. The waveguides 702 may be any suitable waveguides 702, such as waveguides formed using direct laser writing or ion exchange.

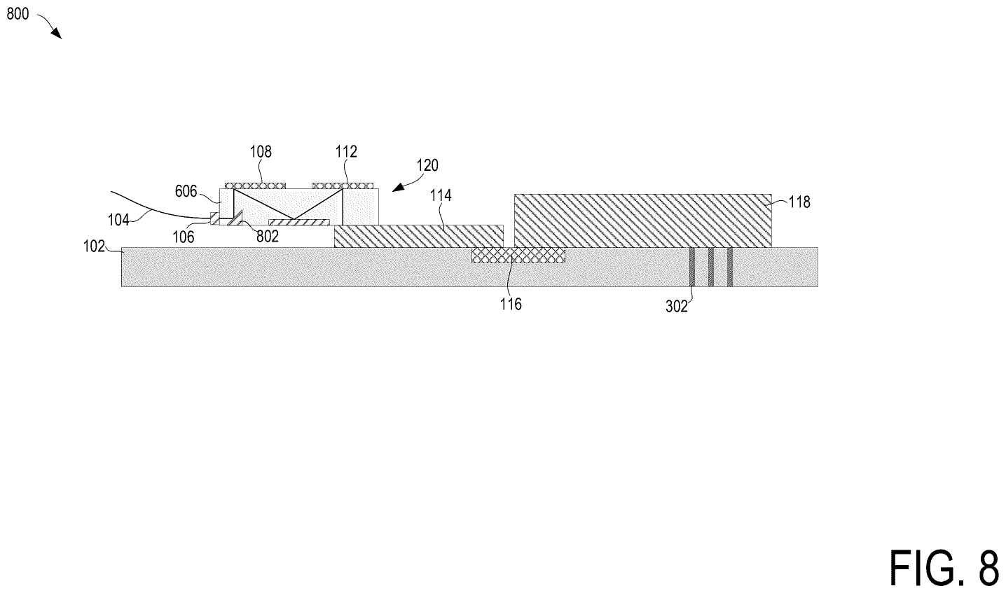

Referring now to FIG. 8, in one embodiment, an integrated circuit package 800 includes an optical equalizer 120 that is mounted directly on the die 114. In such an embodiment, the optical plug 106 with the optical fibers 104 may be plugged directly into the optical equalizer 120, such as by mating with a receptacle mounted on the optical equalizer 120. The light from the optical fiber 104 may be directed to the metasurface 108 using a mirror 802 defined in the substrate 606. In such an embodiment, the optical components of the die 114, such as light sources and/or photodiodes, may be on the opposite side of the die as the substrate 102. In such an embodiment, through-die vias may connect the substrate 102 to the opposite side of the die 114. In other embodiments, the light may extend through the die 114 to or from optical components adjacent to the substrate 102.

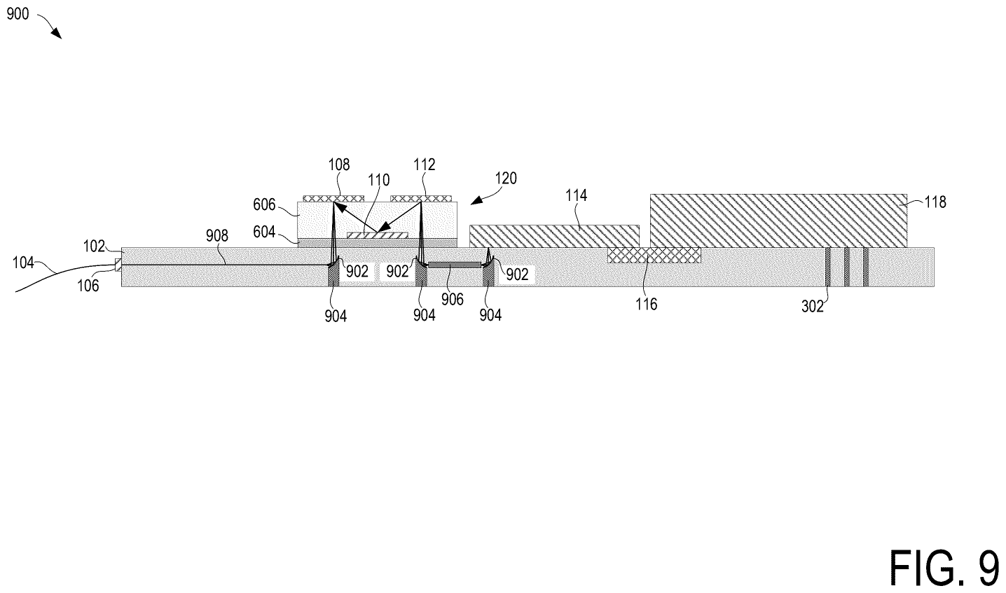

Referring now to FIG. 9, in one embodiment, an integrated circuit package 900 includes an optical equalizer 120, one or more mirrors 902 defined in the substrate 102, a waveguide array 906 with mode groups, and a waveguide array 908 with reduced mode groups. In an illustrative embodiment, light is transmitted from a micro-LED die 114, coupled into a waveguide 906 with mode groups, into the equalizer 120. The equalizer 120 can condition the modes of light, converting the light into certain limited modes that do not couple as much to each other through propagation in the optical fiber 104. The light can then be coupled into a waveguide 908 with reduced mode groups, before being coupled to the optical fiber 104. In such an embodiment, the optical equalizer 120 operates as mode conditioner 120, reducing intermodal dispersion. It should be appreciated that the mode-selective nature of the metasurfaces 108, 112 allows them to be used for mode conditioning and well as equalization. Additionally or alternatively, the optical equalizer 120 can operate as described in regard to, e.g., the integrated circuit package 100, i.e., by compensating for inter-modal dispersion in the optical fiber 104.

In an illustrative embodiment, the micromirrors 902 are embedded in the substrate 102. The curved mirrors 902 may be made of any suitable material, such as a reflective metal such as aluminum, silver, gold, etc. In some embodiments, the curved mirrors 902 may be made of a dielectric stack. In other embodiments, the curved mirror 902 may operate based on total internal reflection. In the illustrative embodiment, the shape of the mirror 902 may be formed by selective laser etching to remove a section 904 from the bottom of the glass substrate 102. A femtosecond laser may be used to increase the susceptibility of part of the glass substrate 102 to etching, and then an etchant such as hydrofluoric acid etches away the treated portion of the glass. After the reflective surface of the mirror 902 is applied, the section 904 may be backfilled with any suitable material, allowing for planarization of the glass substrate 102. In the illustrative embodiment, the mirrors 902 direct the light out of the glass substrate 102 at approximately normal incidence. In other embodiments, the geometry of the mirrors 902 may be tailored to control the angle of the light emerging from the surface of the substrate 102, which may mitigate backreflections from the surface of the substrate 102 or may be used to control incident angles for achieving total internal reflection. In some embodiments, polarization filtering could also be achieved by appropriate geometries to make use of Brewster angles of incidence on the reflecting surfaces.

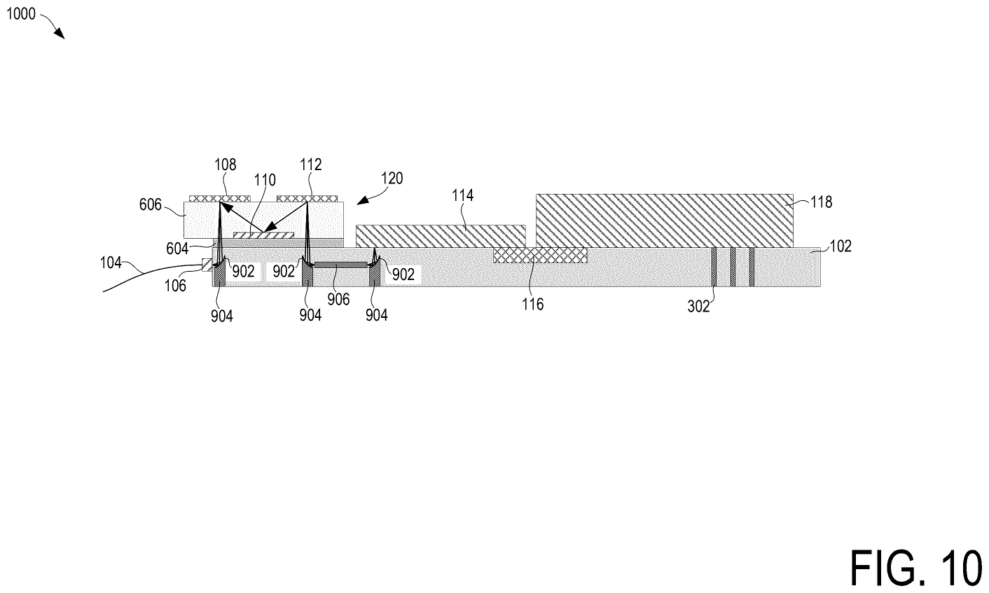

Referring now to FIG. 10, in one embodiment, an integrated circuit package 1000 includes a mode conditioner 120 and/or a mode equalizer 120 mounted on the substrate 102. The light may pass through a waveguide 906 with mode groups, as for the integrated circuit package 900, and after the mode conditioner 120, the light can be directly coupled to the optical fibers 104.

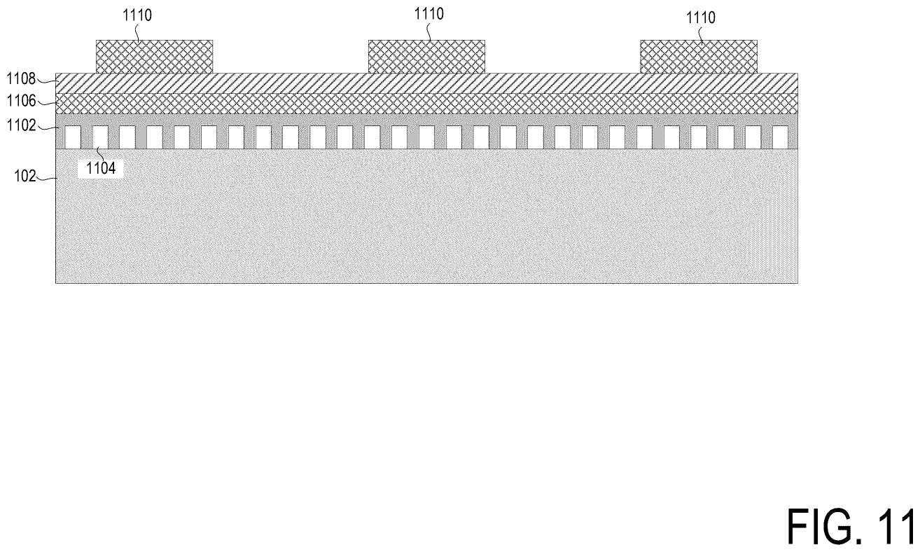

Referring now to FIG. 11, in one embodiment, structure for one possible embodiment of a metasurface is shown. Repeating sub-wavelength structures 1104 embedded in a substrate 1102 form the metasurface. As used herein, a sub-wavelength structure 1104 refers to a repeating structure with a spatial period less than a wavelength of an operating wavelength of the device. For example, for an operating wavelength of 400 nanometers, the sub-wavelength structure 1104 may have a period of 300 nanometers. In general, the sub-wavelength structures 1104 may have any suitable period or pitch, such as 50-1,650 nanometers. The size of the individual structures of the sub-wavelength structures 1104 may be any suitable size, such as 25-1,000 nanometers. It should be appreciated that the sub-wavelength structure is not a perfectly repeating pattern. Rather, a larger-scale pattern for, e.g., amplitude or phase modulation, may be imprinted on the subwavelength pattern. In an illustrative embodiment, the sub-wavelength structure 1104 may be a one-dimensional array or a two-dimensional array of sub-wavelength structure 1104. The two-dimensional array may have a different pitch in the first dimension than the second dimension. The metasurface may be formed on the substrate 102. In an illustrative embodiment, a backside of the metasurface includes a transparent conductive material 1106, such as indium tin oxide (ITO). A dielectric layer 1108 and one or more electrodes 1110 are disposed on the transparent conductive material 1106. In use, a voltage may be applied across the electrodes and the transparent conductive material 1106. The voltage can be used to tune the refractive index of the transparent conductive material 1106 via control of the carrier density, which changes the phase imparted upon the light wave. In an illustrative embodiment, a different voltage may be applied to different electrodes 1110, allowing for different “pixels” of the metasurface to be tuned independently. In this manner, the metasurface can be dynamically programmed to perform different amounts or types of mode equalization. Any suitable number of electrodes 1110 may be included at any suitable pitch, such as an array of 2-100 by 2-100 electrodes 1110 with a pitch of, e.g., 0.5-20 micrometers. In some embodiments, a single back electrode 1110 may be used.

The electrodes 1110 may be any suitable material, such as aluminum. The dielectric layer 1108 may be any suitable material, such as aluminum oxide.

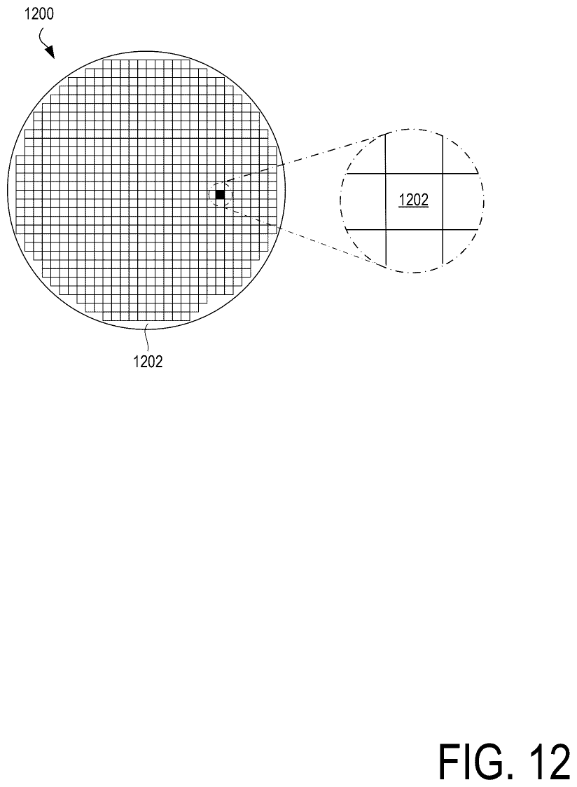

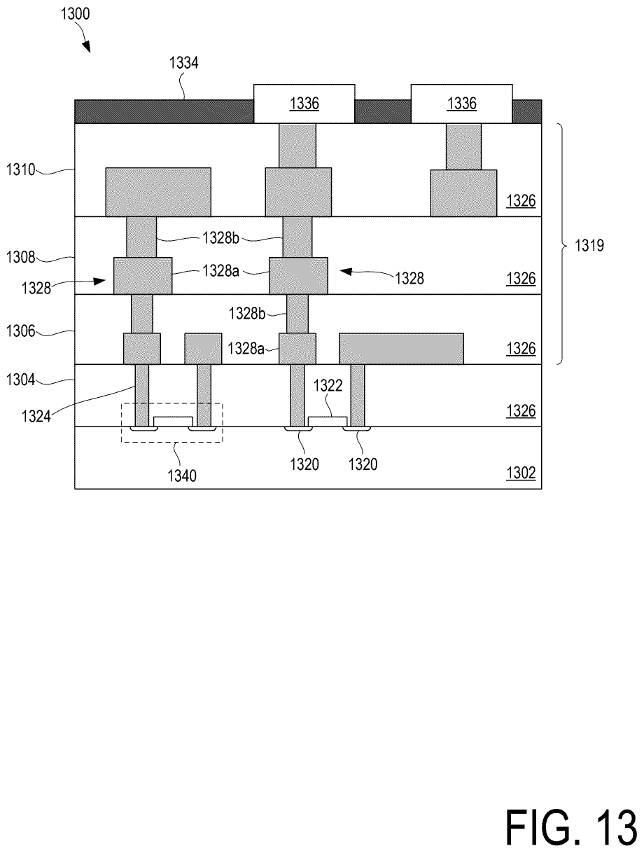

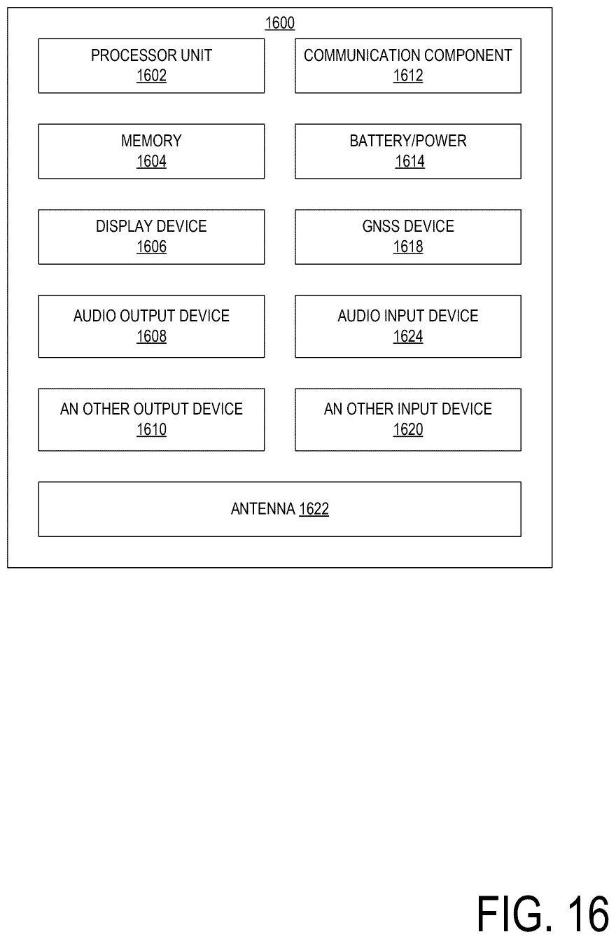

FIG. 12 is a top view of a wafer 1200 and dies 1202 that may be included in any of the integrated circuit packages 100, 600, 700, 800, 900, 1000 disclosed herein (e.g., as any suitable ones of the dies 114, 118). The wafer 1200 may be composed of semiconductor material and may include one or more dies 1202 having integrated circuit structures formed on a surface of the wafer 1200. The individual dies 1202 may be a repeating unit of an integrated circuit product that includes any suitable integrated circuit. After the fabrication of the semiconductor product is complete, the wafer 1200 may undergo a singulation process in which the dies 1202 are separated from one another to provide discrete “chips” of the integrated circuit product. The die 1202 may be any of the dies 114, 118 disclosed herein. The die 1202 may include one or more transistors (e.g., some of the transistors 1340 of FIG. 13, discussed below), supporting circuitry to route electrical signals to the transistors, passive components (e.g., signal traces, resistors, capacitors, or inductors), and/or any other integrated circuit components. In some embodiments, the wafer 1200 or the die 1202 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 1202. For example, a memory array formed by multiple memory devices may be formed on a same die 1202 as a processor unit (e.g., the processor unit 1602 of FIG. 16) or other logic that is configured to store information in the memory devices or execute instructions stored in the memory array. Various ones of the integrated circuit packages 100, 600, 700, 800, 900, 1000 disclosed herein may be manufactured using a die-to-wafer assembly technique in which some dies 114, 118 are attached to a wafer 1200 that include others of the dies 114, 118, and the wafer 1200 is subsequently singulated.

FIG. 13 is a cross-sectional side view of an integrated circuit device 1300 that may be included in any of the integrated circuit packages 100, 600, 700, 800, 900, 1000 disclosed herein (e.g., in any of the dies 114, 118). One or more of the integrated circuit devices 1300 may be included in one or more dies 1202 (FIG. 12). The integrated circuit device 1300 may be formed on a die substrate 1302 (e.g., the wafer 1200 of FIG. 12) and may be included in a die (e.g., the die 1202 of FIG. 12). The die substrate 1302 may be a semiconductor substrate composed of semiconductor material systems including, for example, n-type or p-type materials systems (or a combination of both). The die substrate 1302 may include, for example, a crystalline substrate formed using a bulk silicon or a silicon-on-insulator (SOI) substructure. In some embodiments, the die substrate 1302 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 1302. Although a few examples of materials from which the die substrate 1302 may be formed are described here, any material that may serve as a foundation for an integrated circuit device 1300 may be used. The die substrate 1302 may be part of a singulated die (e.g., the dies 1202 of FIG. 12) or a wafer (e.g., the wafer 1200 of FIG. 12).

The integrated circuit device 1300 may include one or more device layers 1304 disposed on the die substrate 1302. The device layer 1304 may include features of one or more transistors 1340 (e.g., metal oxide semiconductor field-effect transistors (MOSFETs)) formed on the die substrate 1302. The transistors 1340 may include, for example, one or more source and/or drain (S/D) regions 1320, a gate 1322 to control current flow between the S/D regions 1320, and one or more S/D contacts 1324 to route electrical signals to/from the S/D regions 1320. The transistors 1340 may include additional features not depicted for the sake of clarity, such as device isolation regions, gate contacts, and the like. The transistors 1340 are not limited to the type and configuration depicted in FIG. 13 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

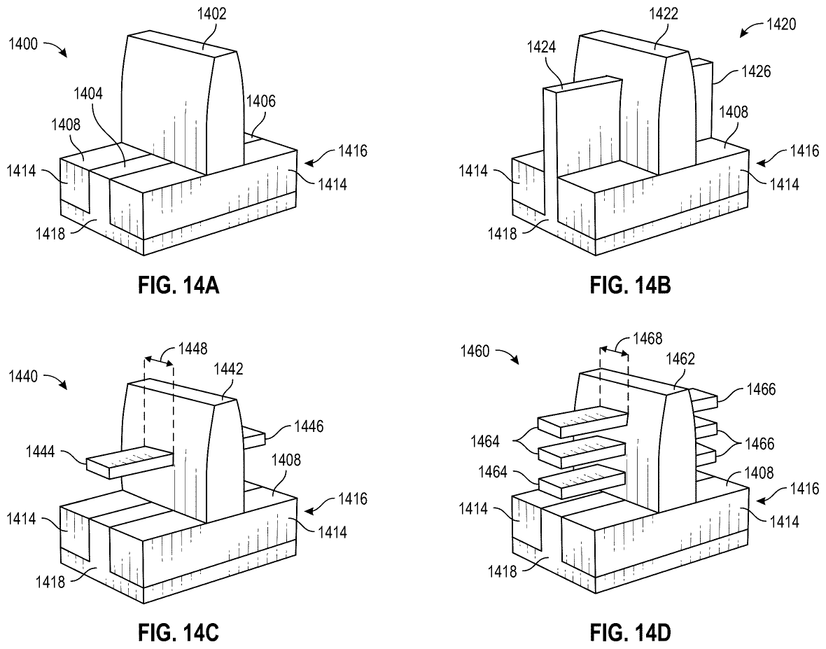

FIGS. 14A-14D are simplified perspective views of example planar, FinFET, gate-all-around, and stacked gate-all-around transistors. The transistors illustrated in FIGS. 14A-14D are formed on a substrate 1416 having a surface 1408. Isolation regions 1414 separate the source and drain regions of the transistors from other transistors and from a bulk region 1418 of the substrate 1416.

FIG. 14A is a perspective view of an example planar transistor 1400 comprising a gate 1402 that controls current flow between a source region 1404 and a drain region 1406. The transistor 1400 is planar in that the source region 1404 and the drain region 1406 are planar with respect to the substrate surface 1408.

FIG. 14B is a perspective view of an example FinFET transistor 1420 comprising a gate 1422 that controls current flow between a source region 1424 and a drain region 1426. The transistor 1420 is non-planar in that the source region 1424 and the drain region 1426 comprise “fins” that extend upwards from the substrate surface 1428. As the gate 1422 encompasses three sides of the semiconductor fin that extends from the source region 1424 to the drain region 1426, the transistor 1420 can be considered a tri-gate transistor. FIG. 14B illustrates one S/D fin extending through the gate 1422, but multiple S/D fins can extend through the gate of a FinFET transistor.

FIG. 14C is a perspective view of a gate-all-around (GAA) transistor 1440 comprising a gate 1442 that controls current flow between a source region 1444 and a drain region 1446. The transistor 1440 is non-planar in that the source region 1444 and the drain region 1446 are elevated from the substrate surface 1428.

FIG. 14D is a perspective view of a GAA transistor 1460 comprising a gate 1462 that controls current flow between multiple elevated source regions 1464 and multiple elevated drain regions 1466. The transistor 1460 is a stacked GAA transistor as the gate controls the flow of current between multiple elevated S/D regions stacked on top of each other. The transistors 1440 and 1460 are considered gate-all-around transistors as the gates encompass all sides of the semiconductor portions that extends from the source regions to the drain regions. The transistors 1440 and 1460 can alternatively be referred to as nanowire, nanosheet, or nanoribbon transistors depending on the width (e.g., widths 1448 and 1468 of transistors 1440 and 1460, respectively) of the semiconductor portions extending through the gate.

Returning to FIG. 13, a transistor 1340 may include a gate 1322 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 1340 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 1340 along the source-channel-drain direction, the gate electrode may consist of a U-shaped structure that includes a bottom portion substantially parallel to the surface of the die substrate 1302 and two sidewall portions that are substantially perpendicular to the top surface of the die substrate 1302. In other embodiments, at least one of the metal layers that form the gate electrode may simply be a planar layer that is substantially parallel to the top surface of the die substrate 1302 and does not include sidewall portions substantially perpendicular to the top surface of the die substrate 1302. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 1320 may be formed within the die substrate 1302 adjacent to the gate 1322 of individual transistors 1340. The S/D regions 1320 may be formed using an implantation/diffusion process or an etching/deposition process, for example. In the former process, dopants such as boron, aluminum, antimony, phosphorous, or arsenic may be ion-implanted into the die substrate 1302 to form the S/D regions 1320. An annealing process that activates the dopants and causes them to diffuse farther into the die substrate 1302 may follow the ion-implantation process. In the latter process, the die substrate 1302 may first be etched to form recesses at the locations of the S/D regions 1320. An epitaxial deposition process may then be carried out to fill the recesses with material that is used to fabricate the S/D regions 1320. In some implementations, the S/D regions 1320 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 1320 may be formed using one or more alternate semiconductor materials such as germanium or a group III-V material or alloy. In further embodiments, one or more layers of metal and/or metal alloys may be used to form the S/D regions 1320.

Electrical signals, such as power and/or input/output (I/O) signals, may be routed to and/or from the devices (e.g., transistors 1340) of the device layer 1304 through one or more interconnect layers disposed on the device layer 1304 (illustrated in FIG. 13 as interconnect layers 1306-1310). For example, electrically conductive features of the device layer 1304 (e.g., the gate 1322 and the S/D contacts 1324) may be electrically coupled with the interconnect structures 1328 of the interconnect layers 1306-1310. The one or more interconnect layers 1306-1310 may form a metallization stack (also referred to as an “ILD stack”) 1319 of the integrated circuit device 1300.

The interconnect structures 1328 may be arranged within the interconnect layers 1306-1310 to route electrical signals according to a wide variety of designs; in particular, the arrangement is not limited to the particular configuration of interconnect structures 1328 depicted in FIG. 13. Although a particular number of interconnect layers 1306-1310 is depicted in FIG. 13, embodiments of the present disclosure include integrated circuit devices having more or fewer interconnect layers than depicted.

In some embodiments, the interconnect structures 1328 may include lines 1328a and/or vias 1328b filled with an electrically conductive material such as a metal. The lines 1328a may be arranged to route electrical signals in a direction of a plane that is substantially parallel with a surface of the die substrate 1302 upon which the device layer 1304 is formed. For example, the lines 1328a may route electrical signals in a direction in and out of the page and/or in a direction across the page. The vias 1328b may be arranged to route electrical signals in a direction of a plane that is substantially perpendicular to the surface of the die substrate 1302 upon which the device layer 1304 is formed. In some embodiments, the vias 1328b may electrically couple lines 1328a of different interconnect layers 1306-1310 together.

The interconnect layers 1306-1310 may include a dielectric material 1326 disposed between the interconnect structures 1328, as shown in FIG. 13. In some embodiments, dielectric material 1326 disposed between the interconnect structures 1328 in different ones of the interconnect layers 1306-1310 may have different compositions; in other embodiments, the composition of the dielectric material 1326 between different interconnect layers 1306-1310 may be the same. The device layer 1304 may include a dielectric material 1326 disposed between the transistors 1340 and a bottom layer of the metallization stack as well. The dielectric material 1326 included in the device layer 1304 may have a different composition than the dielectric material 1326 included in the interconnect layers 1306-1310; in other embodiments, the composition of the dielectric material 1326 in the device layer 1304 may be the same as a dielectric material 1326 included in any one of the interconnect layers 1306-1310.

A first interconnect layer 1306 (referred to as Metal 1 or “M1”) may be formed directly on the device layer 1304. In some embodiments, the first interconnect layer 1306 may include lines 1328a and/or vias 1328b, as shown. The lines 1328a of the first interconnect layer 1306 may be coupled with contacts (e.g., the S/D contacts 1324) of the device layer 1304. The vias 1328b of the first interconnect layer 1306 may be coupled with the lines 1328a of a second interconnect layer 1308.

The second interconnect layer 1308 (referred to as Metal 2 or “M2”) may be formed directly on the first interconnect layer 1306. In some embodiments, the second interconnect layer 1308 may include via 1328b to couple the lines 1328 of the second interconnect layer 1308 with the lines 1328a of a third interconnect layer 1310. Although the lines 1328a and the vias 1328b are structurally delineated with a line within individual interconnect layers for the sake of clarity, the lines 1328a and the vias 1328b may be structurally and/or materially contiguous (e.g., simultaneously filled during a dual-damascene process) in some embodiments.

The third interconnect layer 1310 (referred to as Metal 3 or “M3”) (and additional interconnect layers, as desired) may be formed in succession on the second interconnect layer 1308 according to similar techniques and configurations described in connection with the second interconnect layer 1308 or the first interconnect layer 1306. In some embodiments, the interconnect layers that are “higher up” in the metallization stack 1319 in the integrated circuit device 1300 (i.e., farther away from the device layer 1304) may be thicker that the interconnect layers that are lower in the metallization stack 1319, with lines 1328a and vias 1328b in the higher interconnect layers being thicker than those in the lower interconnect layers.

The integrated circuit device 1300 may include a solder resist material 1334 (e.g., polyimide or similar material) and one or more conductive contacts 1336 formed on the interconnect layers 1306-1310. In FIG. 13, the conductive contacts 1336 are illustrated as taking the form of bond pads. The conductive contacts 1336 may be electrically coupled with the interconnect structures 1328 and configured to route the electrical signals of the transistor(s) 1340 to external devices. For example, solder bonds may be formed on the one or more conductive contacts 1336 to mechanically and/or electrically couple an integrated circuit die including the integrated circuit device 1300 with another component (e.g., a printed circuit board). The integrated circuit device 1300 may include additional or alternate structures to route the electrical signals from the interconnect layers 1306-1310; for example, the conductive contacts 1336 may include other analogous features (e.g., posts) that route the electrical signals to external components.

In some embodiments in which the integrated circuit device 1300 is a double-sided die, the integrated circuit device 1300 may include another metallization stack (not shown) on the opposite side of the device layer(s) 1304. This metallization stack may include multiple interconnect layers as discussed above with reference to the interconnect layers 1306-1310, to provide conductive pathways (e.g., including conductive lines and vias) between the device layer(s) 1304 and additional conductive contacts (not shown) on the opposite side of the integrated circuit device 1300 from the conductive contacts 1336.

In other embodiments in which the integrated circuit device 1300 is a double-sided die, the integrated circuit device 1300 may include one or more through silicon vias (TSVs) through the die substrate 1302; these TSVs may make contact with the device layer(s) 1304, and may provide conductive pathways between the device layer(s) 1304 and additional conductive contacts (not shown) on the opposite side of the integrated circuit device 1300 from the conductive contacts 1336. In some embodiments, TSVs extending through the substrate can be used for routing power and ground signals from conductive contacts on the opposite side of the integrated circuit device 1300 from the conductive contacts 1336 to the transistors 1340 and any other components integrated into the die 1300, and the metallization stack 1319 can be used to route I/O signals from the conductive contacts 1336 to transistors 1340 and any other components integrated into the die 1300.

Multiple integrated circuit devices 1300 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

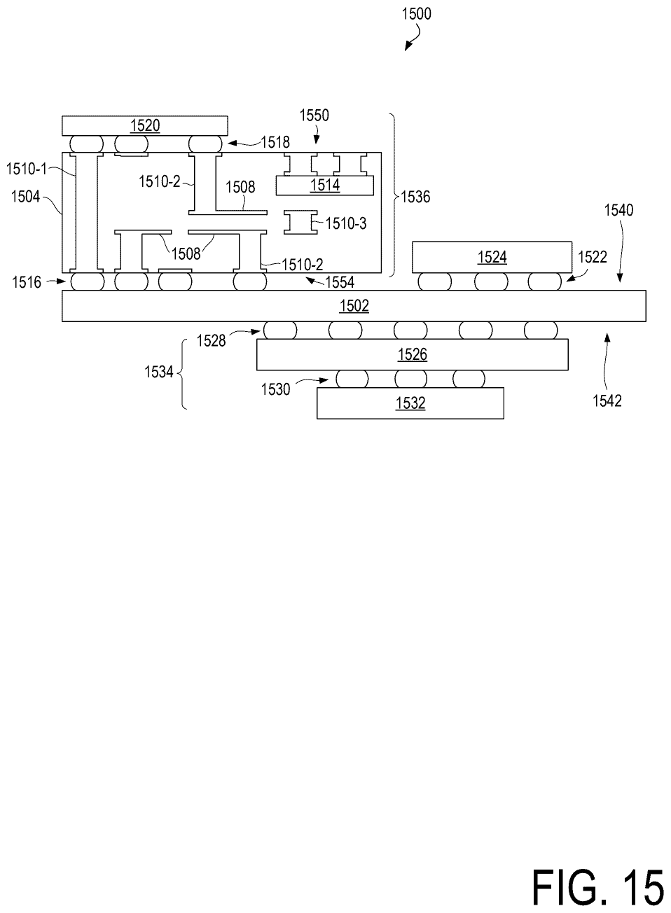

FIG. 15 is a cross-sectional side view of an integrated circuit device assembly 1500 that may include any of the integrated circuit packages 100, 600, 700, 800, 900, 1000 disclosed herein. In some embodiments, the integrated circuit device assembly 1500 may be an integrated circuit package 100, 600, 700, 800, 900, 1000. The integrated circuit device assembly 1500 includes a number of components disposed on a circuit board 1502 (which may be a motherboard, system board, mainboard, etc.). The integrated circuit device assembly 1500 includes components disposed on a first face 1540 of the circuit board 1502 and an opposing second face 1542 of the circuit board 1502; generally, components may be disposed on one or both faces 1540 and 1542. Any of the integrated circuit components discussed below with reference to the integrated circuit device assembly 1500 may take the form of any suitable ones of the embodiments of the integrated circuit packages 100, 600, 700, 800, 900, 1000 disclosed herein.

In some embodiments, the circuit board 1502 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1502. In other embodiments, the circuit board 1502 may be a non-PCB substrate. The integrated circuit device assembly 1500 illustrated in FIG. 15 includes a package-on-interposer structure 1536 coupled to the first face 1540 of the circuit board 1502 by coupling components 1516. The coupling components 1516 may electrically and mechanically couple the package-on-interposer structure 1536 to the circuit board 1502, and may include solder balls (as shown in FIG. 15), pins (e.g., as part of a pin grid array (PGA), contacts (e.g., as part of a land grid array (LGA)), male and female portions of a socket, an adhesive, an underfill material, and/or any other suitable electrical and/or mechanical coupling structure. The coupling components 1516 may serve as the coupling components illustrated or described for any of the substrate assembly or substrate assembly components described herein, as appropriate.

The package-on-interposer structure 1536 may include an integrated circuit component 1520 coupled to an interposer 1504 by coupling components 1518. The coupling components 1518 may take any suitable form for the application, such as the forms discussed above with reference to the coupling components 1516. Although a single integrated circuit component 1520 is shown in FIG. 15, multiple integrated circuit components may be coupled to the interposer 1504; indeed, additional interposers may be coupled to the interposer 1504. The interposer 1504 may provide an intervening substrate used to bridge the circuit board 1502 and the integrated circuit component 1520.

The integrated circuit component 1520 may be a packaged or unpacked integrated circuit product that includes one or more integrated circuit dies (e.g., the die 1202 of FIG. 12, the integrated circuit device 1300 of FIG. 13) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 1520, a single monolithic integrated circuit die comprises solder bumps attached to contacts on the die. The solder bumps allow the die to be directly attached to the interposer 1504. The integrated circuit component 1520 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 1520 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 1520 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 1520 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 1504 may spread connections to a wider pitch or reroute a connection to a different connection. For example, the interposer 1504 may couple the integrated circuit component 1520 to a set of ball grid array (BGA) conductive contacts of the coupling components 1516 for coupling to the circuit board 1502. In the embodiment illustrated in FIG. 15, the integrated circuit component 1520 and the circuit board 1502 are attached to opposing sides of the interposer 1504; in other embodiments, the integrated circuit component 1520 and the circuit board 1502 may be attached to a same side of the interposer 1504. In some embodiments, three or more components may be interconnected by way of the interposer 1504.

In some embodiments, the interposer 1504 may be formed as a PCB, including multiple metal layers separated from one another by layers of dielectric material and interconnected by electrically conductive vias. In some embodiments, the interposer 1504 may be formed of an epoxy resin, a fiberglass-reinforced epoxy resin, an epoxy resin with inorganic fillers, a ceramic material, or a polymer material such as polyimide. In some embodiments, the interposer 1504 may be formed of alternate rigid or flexible materials that may include the same materials described above for use in a semiconductor substrate, such as silicon, germanium, and other group III-V and group IV materials. The interposer 1504 may include metal interconnects 1508 and vias 1510, including but not limited to through hole vias 1510-1 (that extend from a first face 1550 of the interposer 1504 to a second face 1554 of the interposer 1504), blind vias 1510-2 (that extend from the first or second faces 1550 or 1554 of the interposer 1504 to an internal metal layer), and buried vias 1510-3 (that connect internal metal layers).

In some embodiments, the interposer 1504 can comprise a silicon interposer. Through silicon vias (TSV) extending through the silicon interposer can connect connections on a first face of a silicon interposer to an opposing second face of the silicon interposer. In some embodiments, an interposer 1504 comprising a silicon interposer can further comprise one or more routing layers to route connections on a first face of the interposer 1504 to an opposing second face of the interposer 1504.

The interposer 1504 may further include embedded devices 1514, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1504. The package-on-interposer structure 1536 may take the form of any of the package-on-interposer structures known in the art.

The integrated circuit device assembly 1500 may include an integrated circuit component 1524 coupled to the first face 1540 of the circuit board 1502 by coupling components 1522. The coupling components 1522 may take the form of any of the embodiments discussed above with reference to the coupling components 1516, and the integrated circuit component 1524 may take the form of any of the embodiments discussed above with reference to the integrated circuit component 1520.

The integrated circuit device assembly 1500 illustrated in FIG. 15 includes a package-on-package structure 1534 coupled to the second face 1542 of the circuit board 1502 by coupling components 1528. The package-on-package structure 1534 may include an integrated circuit component 1526 and an integrated circuit component 1532 coupled together by coupling components 1530 such that the integrated circuit component 1526 is disposed between the circuit board 1502 and the integrated circuit component 1532. The coupling components 1528 and 1530 may take the form of any of the embodiments of the coupling components 1516 discussed above, and the integrated circuit components 1526 and 1532 may take the form of any of the embodiments of the integrated circuit component 1520 discussed above. The package-on-package structure 1534 may be configured in accordance with any of the package-on-package structures known in the art.

FIG. 16 is a block diagram of an example electrical device 1600 that may include one or more of the integrated circuit packages 100, 600, 700, 800, 900, 1000 disclosed herein. For example, any suitable ones of the components of the electrical device 1600 may include one or more of the integrated circuit device assemblies 1500, integrated circuit components 1520, integrated circuit devices 1300, or integrated circuit dies 1202 disclosed herein, and may be arranged in any of the integrated circuit packages 100, 600, 700, 800, 900, 1000 disclosed herein. A number of components are illustrated in FIG. 16 as included in the electrical device 1600, but any one or more of these components may be omitted or duplicated, as suitable for the application. In some embodiments, some or all of the components included in the electrical device 1600 may be attached to one or more motherboards mainboards, or system boards. In some embodiments, one or more of these components are fabricated onto a single system-on-a-chip (SoC) die.

Additionally, in various embodiments, the electrical device 1600 may not include one or more of the components illustrated in FIG. 16, but the electrical device 1600 may include interface circuitry for coupling to the one or more components. For example, the electrical device 1600 may not include a display device 1606, but may include display device interface circuitry (e.g., a connector and driver circuitry) to which a display device 1606 may be coupled. In another set of examples, the electrical device 1600 may not include an audio input device 1624 or an audio output device 1608, but may include audio input or output device interface circuitry (e.g., connectors and supporting circuitry) to which an audio input device 1624 or audio output device 1608 may be coupled.

The electrical device 1600 may include one or more processor units 1602 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1602 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 1600 may include a memory 1604, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1604 may include memory that is located on the same integrated circuit die as the processor unit 1602. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 1600 can comprise one or more processor units 1602 that are heterogeneous or asymmetric to another processor unit 1602 in the electrical device 1600. There can be a variety of differences between the processing units 1602 in a system in terms of a spectrum of metrics of merit including architectural, microarchitectural, thermal, power consumption characteristics, and the like. These differences can effectively manifest themselves as asymmetry and heterogeneity among the processor units 1602 in the electrical device 1600.

In some embodiments, the electrical device 1600 may include a communication component 1612 (e.g., one or more communication components). For example, the communication component 1612 can manage wireless communications for the transfer of data to and from the electrical device 1600. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1612 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1612 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1612 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1612 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1612 may operate in accordance with other wireless protocols in other embodiments. The electrical device 1600 may include an antenna 1622 to facilitate wireless communications and/or to receive other wireless communications (such as AM or FM radio transmissions).

In some embodiments, the communication component 1612 may manage wired communications, such as electrical, optical, or any other suitable communication protocols (e.g., IEEE 802.3 Ethernet standards). As noted above, the communication component 1612 may include multiple communication components. For instance, a first communication component 1612 may be dedicated to shorter-range wireless communications such as Wi-Fi or Bluetooth, and a second communication component 1612 may be dedicated to longer-range wireless communications such as global positioning system (GPS), EDGE, GPRS, CDMA, WiMAX, LTE, EV-DO, or others. In some embodiments, a first communication component 1612 may be dedicated to wireless communications, and a second communication component 1612 may be dedicated to wired communications.

The electrical device 1600 may include battery/power circuitry 1614. The battery/power circuitry 1614 may include one or more energy storage devices (e.g., batteries or capacitors) and/or circuitry for coupling components of the electrical device 1600 to an energy source separate from the electrical device 1600 (e.g., AC line power).

The electrical device 1600 may include a display device 1606 (or corresponding interface circuitry, as discussed above). The display device 1606 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1600 may include an audio output device 1608 (or corresponding interface circuitry, as discussed above). The audio output device 1608 may include any embedded or wired or wirelessly connected external device that generates an audible indicator, such as speakers, headsets, or earbuds.

The electrical device 1600 may include an audio input device 1624 (or corresponding interface circuitry, as discussed above). The audio input device 1624 may include any embedded or wired or wirelessly connected device that generates a signal representative of a sound, such as microphones, microphone arrays, or digital instruments (e.g., instruments having a musical instrument digital interface (MIDI) output). The electrical device 1600 may include a Global Navigation Satellite System (GNSS) device 1618 (or corresponding interface circuitry, as discussed above), such as a Global Positioning System (GPS) device. The GNSS device 1618 may be in communication with a satellite-based system and may determine a geolocation of the electrical device 1600 based on information received from one or more GNSS satellites, as known in the art.

The electrical device 1600 may include an other output device 1610 (or corresponding interface circuitry, as discussed above). Examples of the other output device 1610 may include an audio codec, a video codec, a printer, a wired or wireless transmitter for providing information to other devices, or an additional storage device.

The electrical device 1600 may include an other input device 1620 (or corresponding interface circuitry, as discussed above). Examples of the other input device 1620 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1600 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1600 may be any other electronic device that processes data. In some embodiments, the electrical device 1600 may comprise multiple discrete physical components. Given the range of devices that the electrical device 1600 can be manifested as in various embodiments, in some embodiments, the electrical device 1600 can be referred to as a computing device or a computing system.

### EXAMPLES

Illustrative examples of the technologies disclosed herein are provided below. An embodiment of the technologies may include any one or more, and any combination of, the examples described below.

Example 1 includes an apparatus comprising a substrate; one or more photodetectors; an optical input; a first dielectric material having an array of first structures at a first pitch, wherein the first pitch is less than 1,600 nanometers, wherein the first dielectric structure is optically coupled to the optical input; and a second dielectric material having an array of second structures at a second pitch, wherein the second pitch is less than 1,600 nanometers, wherein the second dielectric material is optically coupled to the first dielectric material and to the one or more photodetectors.

Example 2 includes the subject matter of Example 1, and wherein an optical path length from the optical input to the one or more photodetectors is spatial-mode-dependent.

Example 3 includes the subject matter of any of Examples 1 and 2, and wherein the first pitch is equal to the second pitch.

Example 4 includes the subject matter of any of Examples 1-3, and wherein the first pitch is more than the second pitch.

Example 5 includes the subject matter of any of Examples 1-4, and wherein the first pitch is less than the second pitch.

Example 6 includes the subject matter of any of Examples 1-5, and wherein the first dielectric material forms a first optical metasurface, wherein the second dielectric material forms a second optical metasurface.

Example 7 includes the subject matter of any of Examples 1-6, and further including a multi-mode optical fiber coupled to the optical input, wherein the spatial-mode-dependent optical path from the optical input to the one or more photodetectors at least partially compensates modal dispersion from the multi-mode optical fiber.

Example 8 includes the subject matter of any of Examples 1-7, and wherein the first dielectric structure comprises a repeating lattice of sub-wavelength structures.

Example 9 includes the subject matter of any of Examples 1-8, and wherein the one or more photodetectors are mounted on the substrate, wherein the substrate comprises a first surface and a second surface opposite the first surface, wherein the first dielectric structure is mounted on the first surface of the substrate, wherein the second dielectric structure is mounted on the second surface of the substrate, wherein, in use, light is to travel from the first dielectric structure to the second dielectric structure through the substrate.

Example 10 includes the subject matter of any of Examples 1-9, and further including an optical equalizer substrate, wherein the optical equalizer substrate comprises a first surface and a second surface opposite the first surface, wherein the first dielectric structure is mounted on the first surface of the optical equalizer substrate, wherein the second dielectric structure is mounted on the second surface of the optical equalizer substrate.

Example 11 includes the subject matter of any of Examples 1-10, and wherein the optical equalizer substrate is mounted on the substrate using index matching epoxy.

Example 12 includes the subject matter of any of Examples 1-11, and wherein the optical equalizer substrate is mounted on the one or more photodetectors.

Example 13 includes the subject matter of any of Examples 1-12, and wherein a first set of one or more waveguides and a second set of one or more waveguides are defined in the substrate, wherein the first set of one or more waveguides couple light from the optical input to the optical equalizer substrate, wherein the second set of one or more waveguides couple light from the optical equalizer substrate to the one or more photodetectors.

Example 14 includes the subject matter of any of Examples 1-13, and wherein the one or more photodetectors comprise one or more microphotodiodes.

Example 15 includes the subject matter of any of Examples 1-14, and further including one or more micro-LEDs; an optical output; a third dielectric structure that forms a third optical metasurface, wherein the third dielectric structure is optically coupled to the one or more micro-LEDs; and a fourth dielectric structure that forms a fourth optical metasurface, wherein the fourth dielectric structure optically coupled to the third dielectric structure and to the optical output, wherein an optical path length from the micro-LEDs to the optical output is spatial-mode-dependent.

Example 16 includes the subject matter of any of Examples 1-15, and further including one or more micro-LEDs; an optical output; a third dielectric structure that forms a third optical metasurface, wherein the third dielectric structure is optically coupled to the one or more micro-LEDs; and a fourth dielectric structure that forms a fourth optical metasurface, wherein the fourth dielectric structure optically coupled to the third dielectric structure and to the optical output, wherein the third optical metasurface and the fourth optical metasurface condition modes from the one or more micro-LEDs before coupling to the optical output.

Example 17 includes the subject matter of any of Examples 1-16, and further including an electronic integrated circuit (EIC) die; and a bridge die coupled to the one or more photodetectors and the EIC die, wherein the EIC die uses data received from the one or more photodetectors without deserialization.

Example 18 includes the subject matter of any of Examples 1-17, and further including a stack adjacent the first optical metasurface, wherein the stack comprises a first electrode, a dielectric layer, and a second electrode, wherein the first electrode is transparent.

Example 19 includes the subject matter of any of Examples 1-18, and further including a stack adjacent the first optical metasurface, wherein the stack comprises a first electrode, a dielectric layer, and an array of second electrodes, wherein the first electrode is transparent, wherein the array of second electrodes comprises at least 100 electrodes.

Example 20 includes the subject matter of any of Examples 1-19, and wherein, in use, a voltage can be applied across individual electrodes of the array of second electrodes to tune different regions of the first optical metasurface.

Example 21 includes the subject matter of any of Examples 1-20, and wherein the first dielectric structure is to reflect a plurality of modes of light, wherein a difference between an angle of incidence and an angle of reflection for the plurality of modes of light upon reflection from the first dielectric structure is spatial-mode-dependent; wherein the second dielectric structure is to reflect the plurality of modes of light, wherein a difference between an angle of incidence and an angle of reflection for the plurality of modes of light upon reflection from the second dielectric structure is spatial-mode-dependent.

Example 22 includes an optical equalizer comprising a first dielectric structure that forms a first optical metasurface, wherein the first dielectric structure is optically coupled to an input of the optical equalizer, wherein the first dielectric structure is to reflect a plurality of modes of light, wherein a difference between an angle of incidence and an angle of reflection for the plurality of modes of light upon reflection from the first dielectric structure is spatial-mode-dependent; and a second dielectric structure that forms a second optical metasurface, wherein the second dielectric structure is optically coupled to an output of the optical equalizer and optically coupled to the first dielectric structure, wherein the second dielectric structure is to reflect the plurality of modes of light, wherein a difference between an angle of incidence and an angle of reflection for the plurality of modes of light upon reflection from the second dielectric structure is spatial-mode-dependent.

Example 23 includes the subject matter of Example 22, and wherein a multi-mode optical fiber is coupled to the optical equalizer, wherein the optical equalizer at least partially compensates modal dispersion from the multi-mode optical fiber.

Example 24 includes the subject matter of any of Examples 22 and 23, and wherein the first dielectric structure comprises a repeating lattice of sub-wavelength structures.

Example 25 includes the subject matter of any of Examples 22-24, and wherein an optical path length from the first optical metasurface to the second optical metasurface is spatial-mode-dependent.

Example 26 includes the subject matter of any of Examples 22-25, and wherein the first optical metasurface and the second optical metasurface condition a plurality of modes of light for low spatial-mode-dispersion when coupled to a multi-mode optical fiber.

Example 27 includes the subject matter of any of Examples 22-26, and further including a stack adjacent the first optical metasurface, wherein the stack comprises a first electrode, a dielectric layer, and a second electrode, wherein the first electrode is transparent.

Example 28 includes the subject matter of any of Examples 22-27, and further including a stack adjacent the first optical metasurface, wherein the stack comprises a first electrode, a dielectric layer, and an array of second electrodes, wherein the first electrode is transparent, wherein the array of second electrodes comprises at least 100 electrodes.

Example 29 includes the subject matter of any of Examples 22-28, and wherein, in use, a voltage can be applied across individual electrodes of the array of second electrodes to tune different regions of the first optical metasurface.

Example 30 includes an integrated circuit package comprising a substrate; one or more photodetectors; an optical input; and means for providing modal dispersion compensation to light received at the optical input and provided to the one or more photodetectors.

Example 31 includes the subject matter of Example 30, and further including a multi-mode optical fiber coupled to the optical input, wherein the means for providing modal dispersion compensation at least partially compensates modal dispersion from the multi-mode optical fiber.

Example 32 includes the subject matter of any of Examples 30 and 31, and wherein the means for providing modal dispersion compensation comprises a repeating lattice of sub-wavelength structures.

Example 33 includes the subject matter of any of Examples 30-32, and wherein the one or more photodetectors are mounted on the substrate, wherein the substrate comprises a first surface and a second surface opposite the first surface, wherein part of the means for providing modal dispersion compensation is mounted on the first surface of the substrate, wherein part of the means for providing modal dispersion compensation is mounted on the second surface of the substrate.

Example 34 includes the subject matter of any of Examples 30-33, and further including an optical equalizer substrate, wherein the means for providing modal dispersion compensation comprises the optical equalizer substrate.

Example 35 includes the subject matter of any of Examples 30-34, and wherein the means for providing modal dispersion compensation is mounted on the substrate using index matching epoxy.

Example 36 includes the subject matter of any of Examples 30-35, and wherein the means for providing modal dispersion compensation is mounted on the one or more photodetectors.

Example 37 includes the subject matter of any of Examples 30-36, and wherein the means for providing modal dispersion compensation comprises at least part of the substrate.

Example 38 includes the subject matter of any of Examples 30-37, and wherein a first set of one or more waveguides and a second set of one or more waveguides are defined in the substrate, wherein the first set of one or more waveguides couple light from the optical input to the means for providing modal dispersion compensation, wherein the second set of one or more waveguides couple light from the means for providing modal dispersion compensation to the one or more photodetectors.

Example 39 includes the subject matter of any of Examples 30-38, and wherein the one or more photodetectors comprise one or more microphotodiodes.

Example 40 includes the subject matter of any of Examples 30-39, and further including one or more micro-LEDs; an optical output; and means for providing modal dispersion compensation to light received from the one or more micro-LEDs and provided to the optical output.

Example 41 includes the subject matter of any of Examples 30-40, and further including one or more micro-LEDs; an optical output; and means for providing mode conditioning for light received from the one or more micro-LEDs and provided to the optical output.

Example 42 includes the subject matter of any of Examples 30-41, and further including an electronic integrated circuit (EIC) die; and a bridge die coupled to the one or more photodetectors and the EIC die, wherein the EIC die uses data received from the one or more photodetectors without deserialization.

Example 43 includes the subject matter of any of Examples 30-42, and further including means for electrically tuning the means for providing modal dispersion compensation.

Example 44 includes the subject matter of any of Examples 30-43, and further including means for electrically tuning a first part of the means for providing modal dispersion compensation and means for electrically tuning a second part of the means for providing modal dispersion different from the first part.

1. An apparatus comprising:
a substrate;
one or more photodetectors;
an optical input;
a first dielectric material having an array of first structures at a first pitch, wherein the first pitch is less than 1,600 nanometers, wherein the first dielectric material is optically coupled to the optical input; and
a second dielectric material having an array of second structures at a second pitch, wherein the second pitch is less than 1,600 nanometers, wherein the second dielectric material is optically coupled to the first dielectric material and to the one or more photodetectors.

2. The apparatus of claim 1, wherein the first pitch is equal to the second pitch.

3. The apparatus of claim 1, wherein the first dielectric material forms a first optical metasurface, wherein the second dielectric material forms a second optical metasurface.

4. The apparatus of claim 1, wherein an optical path length from the optical input to the one or more photodetectors is spatial-mode-dependent.

5. The apparatus of claim 4, further comprising a multi-mode optical fiber coupled to the optical input, wherein the spatial-mode-dependent optical path from the optical input to the one or more photodetectors at least partially compensates modal dispersion from the multi-mode optical fiber.

6. The apparatus of claim 1, wherein the first dielectric material comprises a repeating lattice of sub-wavelength structures.

7. The apparatus of claim 1, wherein the one or more photodetectors are mounted on the substrate, wherein the substrate comprises a first surface and a second surface opposite the first surface, wherein the first dielectric material is mounted on the first surface of the substrate, wherein the second dielectric material is mounted on the second surface of the substrate, wherein, in use, light is to travel from the first dielectric material to the second dielectric material through the substrate.

8. The apparatus of claim 1, further comprising an optical equalizer substrate, wherein the optical equalizer substrate comprises a first surface and a second surface opposite the first surface, wherein the first dielectric material is mounted on the first surface of the optical equalizer substrate, wherein the second dielectric material is mounted on the second surface of the optical equalizer substrate.

9. The apparatus of claim 1, further comprising:
one or more micro-LEDs;
an optical output;
a third dielectric material that forms a third optical metasurface, wherein the third dielectric material is optically coupled to the one or more micro-LEDs; and
a fourth dielectric material that forms a fourth optical metasurface, wherein the fourth dielectric material optically coupled to the third dielectric material and to the optical output,
wherein an optical path length from the one or more micro-LEDs to the optical output is spatial-mode-dependent.

10. The apparatus of claim 1, further comprising:
one or more micro-LEDs;
an optical output;
a third dielectric material that forms a third optical metasurface, wherein the third dielectric material is optically coupled to the one or more micro-LEDs; and
a fourth dielectric material that forms a fourth optical metasurface, wherein the fourth dielectric material optically coupled to the third dielectric material and to the optical output,
wherein the third optical metasurface and the fourth optical metasurface condition modes from the one or more micro-LEDs before coupling to the optical output.

11. The apparatus of claim 1, further comprising:
an electronic integrated circuit (EIC) die; and
a bridge die coupled to the one or more photodetectors and the EIC die,
wherein the EIC die uses data received from the one or more photodetectors without deserialization.

12. The apparatus of claim 1,
wherein the first dielectric material is to reflect a plurality of modes of light, wherein a difference between an angle of incidence and an angle of reflection for the plurality of modes of light upon reflection from the first dielectric material is spatial-mode-dependent;
wherein the second dielectric material is to reflect the plurality of modes of light, wherein a difference between an angle of incidence and an angle of reflection for the plurality of modes of light upon reflection from the second dielectric material is spatial-mode-dependent.

13. An optical equalizer comprising:
a first dielectric structure that forms a first optical metasurface, wherein the first dielectric structure is optically coupled to an input of the optical equalizer, wherein the first dielectric structure is to reflect a plurality of modes of light, wherein a difference between an angle of incidence and an angle of reflection for the plurality of modes of light upon reflection from the first dielectric structure is spatial-mode-dependent; and
a second dielectric structure that forms a second optical metasurface, wherein the second dielectric structure is optically coupled to an output of the optical equalizer and optically coupled to the first dielectric structure, wherein the second dielectric structure is to reflect the plurality of modes of light, wherein a difference between an angle of incidence and an angle of reflection for the plurality of modes of light upon reflection from the second dielectric structure is spatial-mode-dependent.

14. The optical equalizer of claim 13, wherein a multi-mode optical fiber is coupled to the optical equalizer, wherein the optical equalizer at least partially compensates modal dispersion from the multi-mode optical fiber.

15. The optical equalizer of claim 13, further comprising a stack adjacent the first optical metasurface, wherein the stack comprises a first electrode, a dielectric layer, and a second electrode, wherein the first electrode is transparent.

16. The optical equalizer of claim 13, further comprising a stack adjacent the first optical metasurface, wherein the stack comprises a first electrode, a dielectric layer, and an array of second electrodes, wherein the first electrode is transparent, wherein the array of second electrodes comprises at least 100 electrodes.

17. The optical equalizer of claim 16, wherein, in use, a voltage can be applied across individual electrodes of the array of second electrodes to tune different regions of the first optical metasurface.

18. An integrated circuit package comprising:
a substrate;
one or more photodetectors;
an optical input; and
means for providing modal dispersion compensation to light received at the optical input and provided to the one or more photodetectors.

19. The integrated circuit package of claim 18, further comprising a multi-mode optical fiber coupled to the optical input, wherein the means for providing modal dispersion compensation at least partially compensates modal dispersion from the multi-mode optical fiber.

20. The integrated circuit package of claim 18, further comprising means for electrically tuning a first part of the means for providing modal dispersion compensation and means for electrically tuning a second part of the means for providing modal dispersion different from the first part.
